(19) United States
(12) Patent Application Publication
(10) Pub. No.: US 2011/0255590 A1
(43) Pub. Date: Oct. 20, 2011

(54) DATA TRANSMISSION APPARATUS AND METHOD, NETWORK DATA TRANSMISSION SYSTEM AND METHOD USING THE SAME

(75) Inventors: Jun Won KIM, Seoul (KR); Hong Sik YANG, Yongin-si (KR); Jung Yup KIM, Suwon-si (KR)

(73) Assignee: SAMSUNG ELECTRO-MECHANICS CO., LTD., Suwon, Gyunggi-do (KR)

(21) Appl. No.: 12/839,919

(22) Filed: Jul. 20, 2010

(30) Foreign Application Priority Data
Apr. 14, 2010 (KR) 10-2010-0034369

(51) Int. Cl. H04N 11/02

(52) U.S. Cl. 375/240.01; 375/E07.026

(57) ABSTRACT

Disclosed herein are a data transmission apparatus and method, and a network data transmission system and method using the same. A data transmission method according to an exemplary embodiment of the present invention encodes photographed images to generate image live data and generates image analyzing data based on the photographed images. Thereafter, the data transmission method calculates the network transmission bandwidth and stores image live data as image preserving data simultaneously with transmitting the image analyzing data when the network transmission bandwidth is smaller than the predetermined threshold value. If it is determined that the network transmission bandwidth is larger than a predetermined threshold value, the data transmission method transmits the image live data or transmits the image analyzing data and/or the image preserving data along with the image live data.

### CROSS REFERENCE TO RELATED APPLICATION

This application claims the benefit of Korean Patent Application No. 10-2010-0034369, filed on Apr. 14, 2010, entitled “Data Transmission Apparatus And Method, Network Data Transmission System And Method Using The Same”, which is hereby incorporated by reference in its entirety into this application.

### BACKGROUND OF THE INVENTION

1. Technical Field

The present invention relates to a network data transmission technology, and more particularly, to a network data transmission technology capable of performing continuous monitoring at a data receiving side regardless of a network transmission band.

2. Description of the Related Art

With the recent development of a network and the increase in a communication speed, etc., the existing closed circuit television (CCTV) that has been used for monitoring has been changed into a network data transmission system and various applications using a network camera has increased. In the network data transmission system, a network camera is installed at a remote place and images photographed by the network camera are transmitted through a communication network such as the Internet, etc.

In the network data transmission system, when too many users use the corresponding network, the transmitted data amount is increased, such that the network transmission band may be narrow.

At this time, in order to transmit the images photographed in the network camera to the receiving side, the related art has used a method of delaying and transmitting images photographed for a predetermined time. In this case, however, the receiving side does not receive the photographed images of the network camera for a predetermined time (i.e., delayed time), such that the receiving side does not continuously perform the monitoring.

In addition to this, a method of controlling and transmitting transmission data amount per second according to a network transmission band has been used. In this case, however, image quality may be deteriorated when processing and executing the corresponding image at the receiving side.

Therefore, even though the network transmission band is narrow, a need exists for a method capable of continuously receiving and monitoring the photographed images of the network camera without deteriorating the image quality at the receiving side.

### SUMMARY OF THE INVENTION

An object of the present invention transmits image analyzing data and continuously monitors them at a receiving side when a network transmission bandwidth is narrow by generating the image analyzing data based on photographed images.

Other technical problems according to the exemplary embodiments of the present invention can be understood by the following description, which can be implemented by units and a combination thereof included in the claims.

According to an exemplary embodiment of the present invention, there is provided a data transmission apparatus, including: an encoder that encodes photographed images to generate image live data; an image analyzing data generator that generates image analyzing data based on the photographed images; and a controller that controls the image analyzing data generator to generate the image analyzing data.

According to an exemplary embodiment of the present invention, there is provided a data transmission method, including: (A) encoding photographed images by an encoder to generate image live data and generating image analyzing data by an image analyzing data generator based on the photographed images; (B) storing the image live data and the image analyzing data in each independent space by a storage unit; and (C) transmitting at least one of the image live data and the image analyzing data to the outside by a network communication unit according to the corresponding network transmission bandwidth.

According to an exemplary embodiment of the present invention, there is provided a network data transmission system, including: a data receiving apparatus that generates an image analyzing data setting signal and transmits it to the outside and generates an operational mode setting signal according to the corresponding network transmission bandwidth and transmits it to the outside; and a data transmission apparatus that encodes photographed images to generate image live data, generates image analyzing data based on the photographed images according to the image analyzing data setting signal, and controls at least one of the image live data and the image analyzing data to the data receiving apparatus according to the operational mode setting signal.

According to an exemplary embodiment of the present invention, there is provided a network data transmission method, including: (a) generating an image analyzing data setting signal by a data receiving apparatus and transmitting it to the data transmission apparatus; (b) encoding photographed images by the data transmission apparatus to generate image live data and generating image analyzing data based the photographed image according to the image analyzing data setting signal; and (c) generating an operational mode signal by the data receiving apparatus according to the corresponding network transmission bandwidth and transmitting it to the data transmission apparatus.

### BRIEF DESCRIPTION OF THE DRAWINGS

FIG. 1 is a diagram showing a network data transmission system according to an exemplary embodiment of the present invention;

FIG. 2 is a flow chart showing a network data transmission method according to an exemplary embodiment of the present invention;

FIG. 3 is a diagram showing a network data transmission system according to another exemplary embodiment of the present invention; and

FIG. 4 is a flow chart showing a network data transmission method according to another exemplary embodiment of the present invention.

### DESCRIPTION OF THE PREFERRED EMBODIMENTS

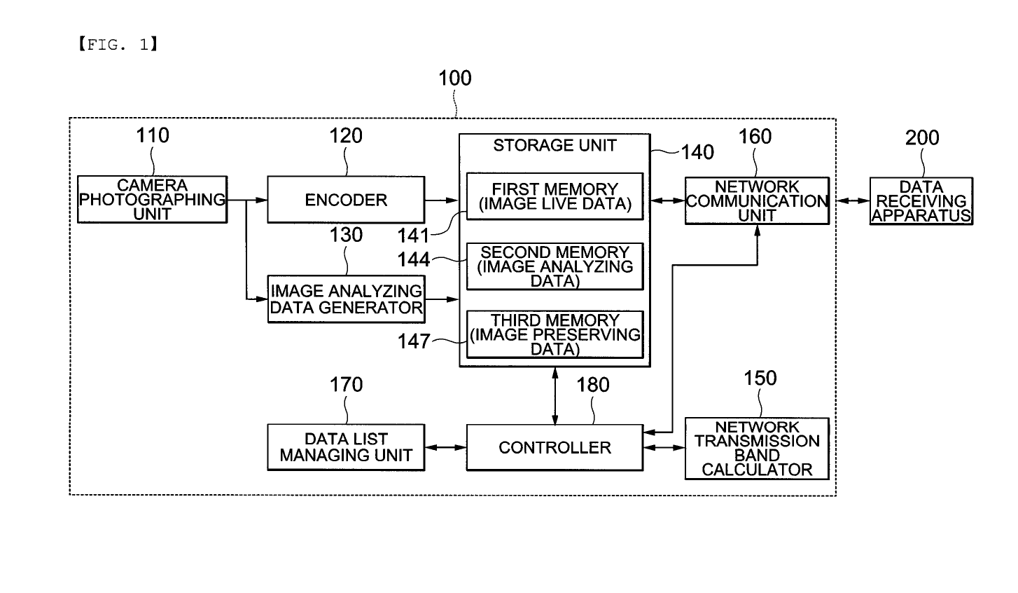

Hereinafter, detailed exemplary embodiments of data transmission apparatus and method and network data transmission system and method using the same according to the present invention will be described with reference to FIGS. 1 to 4. However, the exemplary embodiments are described by way of only examples and the present invention is not limited thereto.

In describing the present invention, detailed description of well-known technology relating to the present invention may unnecessarily make unclear the spirit of the present invention, the detailed description is not provided. Further, the following terminologies are defined in consideration of the functions in the present invention and may be construed in different ways by the intention of users and operators. Therefore, the definition should be made on the basis of the description of the specification.

Further, in the following exemplary embodiments of the present invention, components previously included in a system or components of a system generally included in the technical field belonging to the present invention will be omitted in order to efficiently describe the technical components configuring the present invention and components further included for the present invention will be mainly described. A person skilled in the art to which the present invention belongs can easily understand a function of components previously used in the related art among the omitted components (not shown) and clearly understand the relationship between the components omitted as described above and added components for the present invention.

As a result, the spirit of the present invention is determined by the claims and the following exemplary embodiments may be provided to efficiently describe the spirit of the present invention to those skilled in the art.

FIG. 1 is a diagram showing a configuration of a network data transmission system according to an exemplary embodiment of the present invention. Herein, a network data transmission system will be described as network camera system by way of example. However, the present invention is not limited to a network camera system and may be applied to various systems transmitting various data through a network.

Referring to FIG. 1, the network data transmission system includes a network camera 100 and a data receiving apparatus 200. The network camera 100 and the data receiving apparatus 200 communicate data through various networks such as Internet or Intranet, etc. Herein, the network camera 100 is only one example of a data transmission apparatus that transmits data through a network.

The network camera 100 includes a camera photographing unit 110, an encoder 120, an image analyzing data generator 130, a storage unit 140, a network transmission band calculator 150, a network communication unit 160, a data risk managing unit 170, and a controller 180.

The camera photographing unit 110 transmits images photographed by a camera to the encoder 120 and the image analyzing data generator 130 according to the control of the controller 180.

The encoder 120 encodes the photographed images and transmits them to the storage unit 140. At this time, the photographed and encoded data are called “image live data.” Herein, the encoder 120 compresses the photographed images and then, encrypts them for security of data.

The image analyzing data generator 130 generates the image analyzing data of the corresponding images based on the photographed images and transmits them to the storage unit 140. Herein, the ‘image analyzing data’ are called additional data from results obtained by processing the photographed images. In other words, the image analyzing data are a kind of meta data for the photographed images.

For example, as the image analyzing data, there may be face recognition information, expression recognition information, moving body recognition information, moving body tracing information, character recognition information, identity detection information, scene changing information, etc. In addition to this, various kinds of information can be used according to a demand of a user. For example, as the image analyzing data, the size, the photographing time, and so on of the photographed image may also be used.

Herein, when the face recognition information, the moving body recognition information, the lane recognition information, and so on, are used as the image analyzing data, the image analyzing data include information as to whether the corresponding object is recognized in the photographed images, information on the position and size of the recognized object, and so on.

When the moving body tracing information is used as the image analyzing data, the image analyzing data include the recognition of the corresponding target or not, the position and size information of the recognition target, the moving direction and path coordinate of the recognition target, etc.

When the character recognition information is used as the image analyzing data, the image analyzing data includes the recognition of a character or not and the recognized character, etc. When the scene changing information is used as the image analyzing data, the image analyzing data includes the brightness change of the corresponding image and the motion change of the specific target, etc. Herein, the size of the image analyzing data is smaller than the image live data. For example, if the JPEG file (i.e., image live data) having 640×480 size is 100 Kbyte, when the image analyzing data includes only the recognition of the specific target or not, the size of the image analyzing data is several Bytes to several tens of Bytes.

As another example, when the corresponding network data transmission system is used for the face recognition technology and the moving body tracing technology, the image analyzing data generator 130 receives the photographed images from the camera photographing unit 110, it extracts the recognition of a face or not and the positional information of the recognized face range from the corresponding image to generate the image analyzing data.

When the next photographed image is input from the camera photographing unit 110, the image analyzing data generator 130 extracts the motion recognition or not, the motion direction, and the path coordinate, etc., from the corresponding image to generate the image analyzing data. At this time, the size of the image analyzing data including the recognition of face or not, the position of the recognized face range, the motion recognition or not, the motion direction, and the path coordinate, etc., is about several tens of Byte.

The storage unit 140 includes a first memory 141, a second memory 144, and a third memory 147. The first memory 141 stores the image live data and the second memory 144 stores the image analyzing data. The third memory 147 stores data that are not transmitted to the data receiving apparatus 200, among the image live data. This data is called ‘image preserving data’.

The network transmission band calculator 150 calculates the network transmission bandwidth to which the network camera 100 and the data receiving apparatus 200 belong and transmits it to the controller 180. Generally, the network transmission bandwidth is frequently changed according to the corresponding network environment. Therefore, the network transmission bandwidth is calculated in real time or periodically by the network transmission band calculator 150 and is transmitted to the controller 180.

For example, the network transmission band calculator 150 transmits a separate data packet for calculating the network transmission bandwidth to the data receiving apparatus 200 and then, receives the arriving interval of the data packets and the data receiving success or failure, etc., from the data receiving apparatus 200, thereby making it possible to calculate the corresponding network transmission bandwidth.

The method for calculating the network transmission bandwidth by the network transmission band calculator 150 is not limited to the foregoing. Therefore, the corresponding network transmission bandwidth can be calculated by various methods. For example, the network transmission band calculator 150 transmits a simple network management protocol (SNMP) query to a router (not shown), thereby making it possible to collect information on the transmission bandwidth of the corresponding network.

The network communication unit 160 transmits at least one of data (i.e., image live data, image analyzing data, and image preserving data) stored in the storage unit 140 to the data receiving apparatus 200 according to the control of the controller 180.

For example, the network communication unit 160 extracts the image analyzing data from the storage unit 140 and transmits them to the data receiving apparatus 200 when the network transmission bandwidth is smaller than the predetermined threshold value. Since the size of the image analyzing data is much smaller than the image live data, they can be transmitted without being delayed even though the network transmission bandwidth is narrow.

The network communication unit 160 extracts the image live data from the storage unit 140 and transmits them to the data receiving apparatus 200 when the network transmission bandwidth is larger than the predetermined threshold value. At this time, when there is a sufficient margin in the network transmission bandwidth, at least one of the image analyzing data and the image preserving data may be transmitted along with the image live data.

The data list managing unit 170 manages the list of the image preserving data according to the control of the controller 180. For example, the data list managing unit 170 registers the data, which are not transmitted to the data receiving apparatus 200 in real time among the image live data, in the list.

The data list managing unit 170 deletes the data, which are transmitted to the data receiving apparatus 200 among the image preserving data registered in the list, from the list.

The controller 180 controls each component. For example, the controller 180 uses the images photographed by the camera photographing unit 110 to control the image analyzing data generator 130 in order to generate the image analyzing data of the corresponding image. At this time, the controller 180 may control the kind of image analyzing data (for example, face recognition information, expression recognition information, moving body recognition information, moving body tracing information, character recognition information, identity detection information, and scene changing information, etc.) to be generated by the image analyzing data generator 130.

The controller 180 controls the storage unit 140 to store the data (that is, image live data) encoded by the encoder 120 in the first memory 141. The controller 180 controls the storage unit 140 in order to store the image analyzing data generated by the image analyzing data generator 130 in the second memory 144. The controller 180 controls the storage unit 140 to store the data (that is, image preserving data) that is not transmitted to the data receiving apparatus 200 among the image live data in the third memory 147.

The controller 180 controls the network transmission band calculator 150 to calculate the network transmission bandwidth belonging to the network camera 100 and the data receiving apparatus 200. At this time, the controller 180 may perform a control to allow the network transmission band calculator 150 to calculate the corresponding network transmission bandwidth in real time or periodically and if necessary, may perform a control to calculate the corresponding network transmission bandwidth.

The controller 180 controls the network communication unit 160 to transmit the image analyzing data stored in the second memory 144 to the data receiving apparatus 200 when the calculated network transmission bandwidth is smaller than the predetermined threshold value. At this time, the controller 180 controls the storage unit 140 to store the image live data (that is, image preserving data) that is not transmitted to the data receiving apparatus 200 in the third memory 147. In this case, the controller 180 controls the data list managing unit 170 to register the image preserving data stored in the third memory 147 in the list.

Herein, the controller 180 may move and store the image live data stored in the first memory 141 as the image preserving data in the third memory 147. Further, the controller 180 may immediately store the image live data output from the encoder 120 in the third memory 147.

In detail, the image live data output from the encoder 120 is temporarily stored in the first memory 141 and then transmitted to the data receiving apparatus 200. However, when the network transmission bandwidth is smaller than the predetermined threshold value, the image live data may move from the first memory 141 to the third memory 147 and may be stored in the third memory 147 and may be immediately stored in the third memory 147 without being subjected to the process of storing the image live data in the first memory 141.

The controller 180 controls the network communication unit 160 to transmit the image live data stored in the first memory 141 to the data receiving apparatus 200 when the calculated network transmission bandwidth is larger than the predetermined threshold value. In other words, the controller 180 controls the network communication unit 160 to immediately transmit the image live data output from the encoder 120 and stored in the first memory 141 to the data receiving apparatus 200.

At this time, the controller 180 may control the network communication unit 160 in order to transmit at least one of the image analyzing data stored in the second memory 144 and the image preserving data stored in the third memory 147 to the data receiving apparatus 200, together with the image live data, when there is an sufficient margin in the network transmission bandwidth.

Further, the controller 180 may control the network communication unit 160 to transmit only the image preserving data stored in the third memory 147 to the data receiving apparatus 200 when the calculated network transmission bandwidth is larger than the predetermined threshold value. In this case, the controller 180 controls the data list managing unit 170 to delete the image preserving data transmitted to the data receiving apparatus 200 from the list.

In other words, when the network transmission bandwidth is smaller than the predetermined threshold value, it is difficult to transmit the image live data having a large data size. Therefore, the data receiving apparatus 200 may continuously receive data by transmitting the image analyzing data of the corresponding image having a relatively small data size. In this case, although the network transmission bandwidth is narrow, the data receiving apparatus 200 can continuously receive images photographed by the network camera 100 and monitor the images. The image live data is stored in the third memory 147 and is transmitted to the data receiving apparatus 200 when the network transmission bandwidth is expanded.

For example, when the corresponding network data transmission system is used for the moving body tracing technology, the image analyzing data (for example, recognition or not, the position and size of the recognized target, the motion direction and path coordinate of the recognized target, etc.) instead of the image live data is transmitted when the network transmission bandwidth is smaller than the predetermined threshold value. In this case, the data receiving apparatus 200 can continuously perform the moving body tracing by only using the image analyzing data. Thereafter, when the network transmission bandwidth is expanded, this can be achieved by transmitting only the image preserving data stored in the third memory 147.

The data receiving apparatus 200 receives at least one of the image live data, the image analyzing data, and the image preserving data from the network camera 100. The data receiving apparatus 200 may be any one of a personal computer (PC), a network video recorder (NVR), a digital video recorder (DVR), and a notebook, but is not limited thereto. Therefore, the data receiving apparatus 200 may use various devices in addition to these devices.

The data receiving apparatus 200 may decode the received image live data and image preserving data and then display and monitor them on a screen. At this time, the images photographed by the network camera 100 are displayed on the screen as they are.

The data receiving apparatus 200 may display and monitor the received image analyzing data on the screen. For example, when the image analyzing data is the moving body tracing information, the data receiving apparatus 200 can mark an initial position of a specific target on the screen and then, trace and display the moving path of the specific target. In addition, the data receiving apparatus 200 may display the image analyzing data (for example, whether the specific target is recognized, etc.) itself on the screen.

According to the exemplary embodiment of the present invention, even though the network transmission band is narrow, it can continuously transmit the information on the photographed images without the delay of transmission and the loss of data, thereby making it possible to continuously monitor it in the data receiving apparatus.

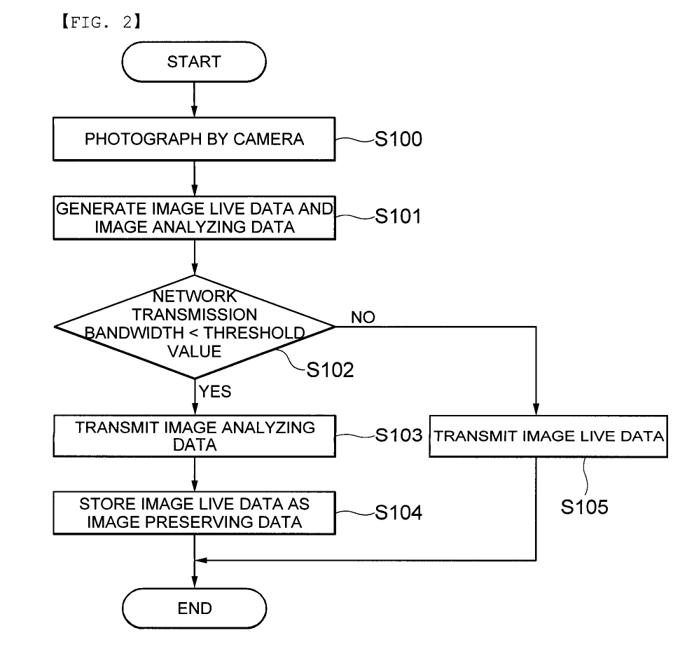

FIG. 2 is a flow chart showing the network data transmission method according to an embodiment of the present invention.

Referring to FIG. 2, the photographing unit 110 of the network camera 100 photographs peripheral backgrounds (S100).

Next, the encoder 120 encodes the photographed images to generate the image live data and the image analyzing data generator 130 uses the photographed images to generate the image analyzing data of the corresponding images (S101). At this time, the controller 180 stores the image live data in the first memory 141 and the image analyzing data in the second memory 144.

Subsequently, the controller 180 confirms whether the network transmission bandwidth is smaller than the predetermined threshold value (S102). If it is determined that the network transmission bandwidth is smaller than the predetermined threshold value, the controller 180 transmits the image analyzing data stored in the second memory 144 to the data receiving apparatus 200 through the network communication unit 160 (S103).

The controller 180 stores the image live data in the third memory 147 (S104). At this time, the image live data stored in the third memory 147 becomes the image preserving data. Herein, steps S103 and S104 do not necessarily have a temporal sequence, but can be simultaneously executed.

As a confirmation result of step S102, if it is determined that the network transmission bandwidth is larger than the predetermined threshold value, the controller 180 transmits the image live data stored in the first memory 141 to the data receiving apparatus 200 through the network communication unit 160. At this time, the controller 180 may transmit at least one of the image analyzing data and the image preserving data along with the image live data.

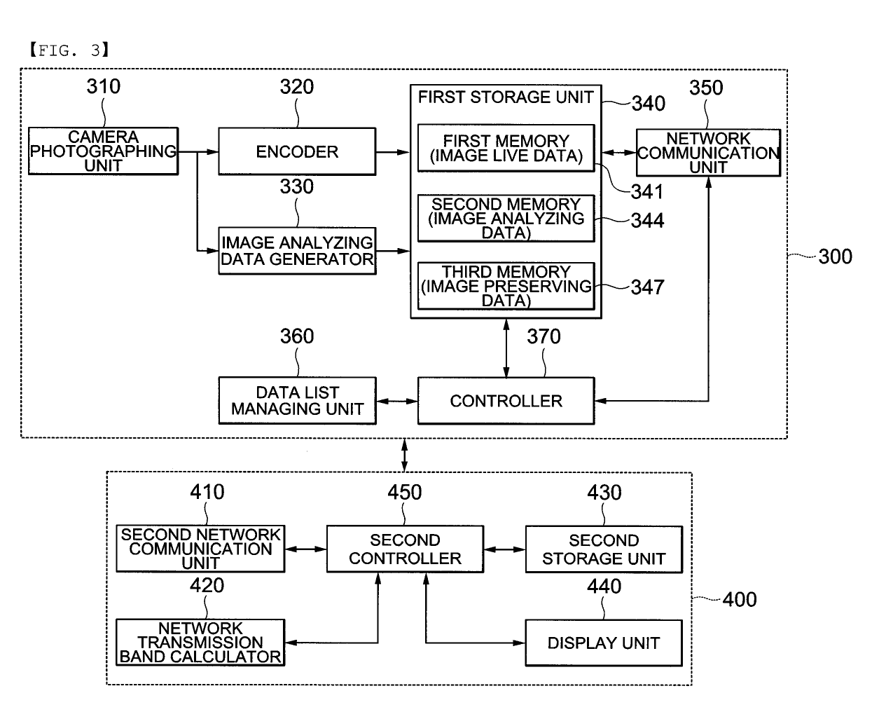

FIG. 3 is a diagram showing a configuration of a network data transmission system according to another exemplary embodiment of the present invention.

Referring to FIG. 3, the network data transmission system includes a network camera 300 and a data receiving apparatus 400. Herein, the network camera 300 and the data receiving apparatus 400 communicate data through various communication networks such as the Internet or Intranet, etc.

The network camera 300 includes a camera photographing unit 310, an encoder 320, an image analyzing data generator 330, a first storage unit 340, a first network communication unit 350, a data list managing unit 360, and a first controller 370.

The camera photographing unit 310 transmits images photographed by a camera to the encoder 320 and the image analyzing data generator 330 according to the control of the controller 370.

The encoder 320 encodes the photographed images and then, transmits them to the first storage unit 340. At this time, the photographed and encoded data are called “image live data.”

The image analyzing data generator 330 generates the image analyzing data of the corresponding images using the photographed images and then transmits them to the first storage unit 340. Herein, the ‘image analyzing data’ are called additional data from results obtained by analyzing the photographed images.

The first storage unit 340 includes a first memory 341, a second memory 344, and a third memory 347. The first memory 341 stores the image live data and the second memory 344 stores the image analyzing data. The third memory 347 stores data that are not transmitted to the data receiving apparatus 400, among the image live data. This data is called ‘image preserving data’.

The first network communication unit 350 communicates with the data receiving apparatus 400. For example, the first communication unit 350 receives an operational mode setting signal or an image analyzing data setting signal, etc., from the data receiving apparatus 400 and transmits them to the first controller 370.

Herein, the operational mode setting signals means a signal setting the operational mode to the network camera 300 that transmits any of the image live data, the image analyzing data, and the image preserving data. The image analyzing data setting signal means a signal setting whether the image analyzing data generator 330 uses the photographed images to generate any type of image analyzing data. The detailed description of the operational mode setting signal and the image analyzing data setting signal will be described below.

The first network communication unit 350 transmits at least one of data (i.e., image live data, image analyzing data, and image preserving data) stored in the first storage unit 340 to the data receiving apparatus 400 according to the control of the first controller 370.

The data list managing unit 360 manages the list of the image preserving data according to the control of the first controller 370. For example, the data list managing unit 360 registers the data that are not transmitted to the data receiving apparatus 400 among the image live data in the list. The data list managing unit 360 deletes the data, which are transmitted to the data receiving apparatus 400 among the image preserving data registered in the list, from the list.

The first controller 370 controls each component. For example, the first controller 370 uses the images photographed by the camera photographing unit 310 to control the image analyzing data generator 330 in order to generate the image analyzing data of the corresponding image. At this time, the first controller 370 controls the type of image analyzing data to be generated by the image analyzing data generator 330 according to the image analyzing data setting signal received from the data receiving apparatus 400.

The first controller 370 controls the first storage unit 340 to store the data (that is, image live data) encoded by the encoder 320 in the first memory 341. The first controller 370 controls the first storage unit 340 in order to store the image analyzing data generated by the image analyzing data generator 330 in the second memory 344. The first controller 370 controls the first storage unit 340 to store the data (that is, image preserving data) that is not transmitted to the data receiving apparatus 400 among the image live data in the third memory 347.

The first controller 370 controls the first network communication unit 350 to transmit at least one of data (i.e., image live data, image analyzing data, and image preserving data) stored in the first storage unit 340 to the data receiving apparatus 400 according to the operational mode setting signal received from the data receiving apparatus 400.

In detail, the data receiving apparatus 400 transmits the operational mode setting signal to the network camera 300 according to the network transmission bandwidth to which the network camera 300 and the data receiving apparatus 400 belong.

For example, when the corresponding network transmission bandwidth is smaller than the predetermined threshold value, the data receiving apparatus 400 may transmit the first operational mode setting signal, which is a signal storing the image live data in the third memory 347 while simultaneously transmitting the image analyzing data, to the network camera 300. At this time, the first controller 370 transmits the image analyzing data to the data receiving apparatus 400 and at the same time, stores the image live data in the third memory 347. In this case, the first controller 370 controls the data list managing unit 360 to register the image preserving data stored in the third memory 347 in the list.

When the corresponding network transmission bandwidth is larger than the predetermined threshold value, the data receiving apparatus 400 may transmit the second operational mode setting signal, which is a signal transmitting the image live data, to the network camera 300. At this time, the network camera 300 immediately transmits the image live data, which are output from the encoder 320 and stored in the first memory 341, to the data receiving apparatus 400.

Further, when the corresponding network transmission bandwidth is larger than the predetermined threshold value, if there is sufficient margin in the network transmission bandwidth, the data receiving apparatus 400 may transmit the third operational mode setting signal, which is a signal transmitting at least one of the image analyzing data and the image preserving data along with the image live data, to the network camera 300.

At this time, the network camera 300 transmits the image analyzing data and/or the image preserving data along with the image live data to the data receiving apparatus 400 according to the third operational mode setting signal. In this case, the first controller 370 controls the data list managing unit 170 to delete the image preserving data transmitted to the data receiving apparatus 400 from the list.

The data receiving apparatus 400 includes a second network communication unit 410, a network transmission band calculator 420, a second storage unit 430, a display unit 440, and a second controller 450.

The second network communication unit 410 communicates data with the first network communication unit 350. For example, the second network communication unit 410 transmits the operational mode setting signal and the image analyzing data setting signal to the first network communication unit 350. It receives at least one of the image live data, the image analyzing data, and the image preserving data from the first network communication unit 350.

The network transmission band calculator 420 calculates the network transmission bandwidth to which the network camera 300 and the data receiving apparatus 400 belong according to the control of the second controller 450 and transmits it to the second controller 450.

The second storage unit 430 stores the image live data, the image analyzing data, and the image preserving data that are received by the second network communication unit 410. At this time, the second storage unit 430 may store the received data for each network camera.

The display unit 440 performs the image processing (for example, decoding, etc.) on the image live data and the image preserving data received by the second network communication unit 410 according to the control of the second controller 450 and displays them on the screen. The display unit 440 displays the image analyzing data received by the second network communication unit 410 on the screen. At this time, the display unit 440 may display the image analyzing data themselves on the screen and reflect the analyzing results of the image analyzing data and display them on the screen.

The second controller 450 controls each component. For example, the second controller 450 controls the second network communication unit 410 to generate the image analyzing data setting signal and transmits them to the network camera 300. The second controller 450 may control the type of the image analyzing data to be generated by the network camera 300 through the image analyzing data setting signal.

The second controller 450 controls the network transmission band calculator 420 to calculate the network transmission bandwidth to which the network camera 300 and the data receiving apparatus 400 belong. At this time, the second controller 450 may perform a control to allow the network transmission band calculator to calculate the corresponding network transmission bandwidth in real time or periodically and if necessary, may perform a control to calculate the corresponding network transmission bandwidth.

The second controller 450 controls the second network communication unit 410 to generate the first operational mode setting signal and then transmits the first operational mode setting signal to the network camera 300 when the calculated network transmission bandwidth is smaller than the predetermined threshold value.

The second controller 450 controls the second network communication unit 410 to generate the second operational mode setting signal and then transmits the second operational mode setting signal to the network camera 300 when the calculated network transmission bandwidth is larger than the predetermined threshold value.

When the calculated network transmission bandwidth is larger than the predetermined threshold value, if there is sufficient margin in the network transmission bandwidth, the second controller 450 controls the second network communication unit 410 to generate the third operational mode setting signal and then transmits the third operational mode setting signal to the network camera 300.

The second controller 450 controls the display unit 400 to display the image live data, the image analyzing data, and the image preserving data that are received by the second network communication unit 410 on the screen.

Although it describes that the data receiving apparatus 400 calculates the corresponding network transmission bandwidth, it is not necessarily limited thereto. If the network camera 300 calculates the network transmission bandwidth and transmits it to the data receiving apparatus 400, the data receiving apparatus 400 may generate the corresponding operational mode setting signal according to the network transmission bandwidth.

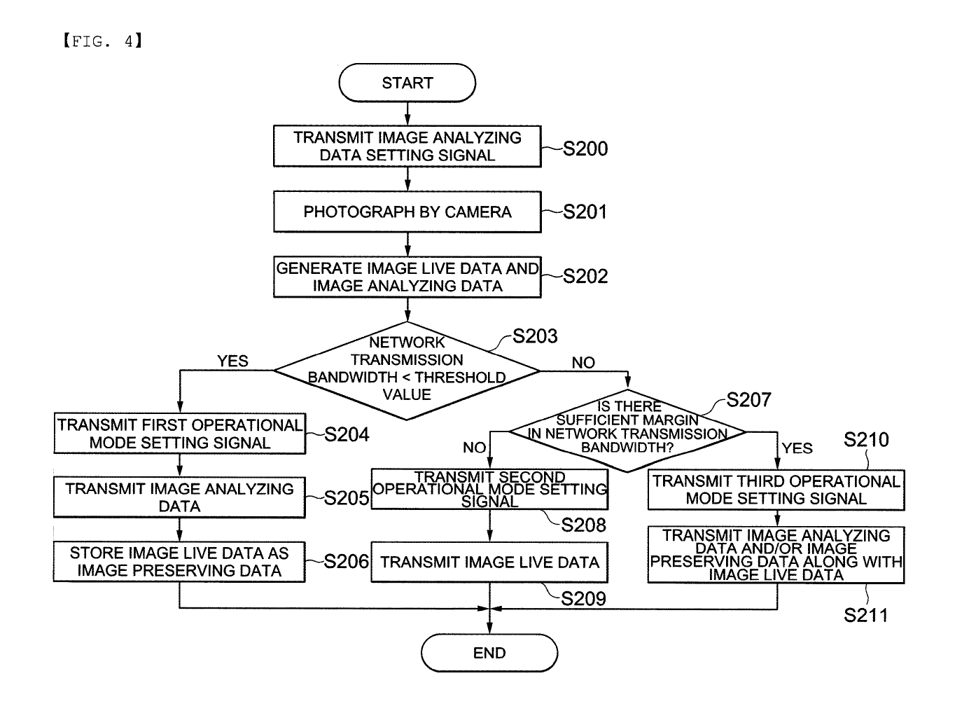

FIG. 4 is a flow chart showing a network data transmission method according to another exemplary embodiment of the present invention.

Referring to FIG. 4, the data receiving apparatus 400 first generates the image analyzing data setting signals and transmits them to the network camera 300 (S200).

Next, the network camera 300 photographs the peripheral backgrounds (S201) and encodes the photographed images to generate the image live data and uses the photographed images to generate the image analyzing data of the corresponding image (S202). At this time, the network camera 300 generates the image analyzing data according to the image analyzing data setting signal. The sequence of steps S200 and S201 may be changed.

Next, the data receiving apparatus 400 confirms the corresponding network transmission bandwidth (S203) to generate the first operational mode setting signal and transmits it to the network camera 300 when the network transmission bandwidth is smaller than the predetermined threshold value (S204).

Then, the network camera 300 transmits the image analyzing data to the data receiving apparatus 400 (S205) and stores the image live data in the third memory 347 (S206). At this time, the image live data stored in the third memory 347 becomes the image preserving data. Herein, steps S205 and S206 do not necessarily have a temporal sequence, but can be simultaneously executed.

As the confirmation result of step S203, when the network transmission bandwidth is larger than the predetermined threshold value, the data receiving apparatus 400 confirms whether there is sufficient margin in the network transmission bandwidth (S207). For example, the data receiving apparatus 400 confirms whether the network transmission bandwidth has a margin capable of transmitting other data in addition to the image live data.

As the confirmation result of step S207, when there is no margin in the network transmission bandwidth, the data receiving apparatus 400 generates the second operational mode setting signal and transmits it to the network camera 300 (S208). Then, the network camera 300 transmits the image live data to the data receiving apparatus 400 (S209).

As the confirmation result of step S207, when there is a sufficient margin in the network transmission bandwidth, the data receiving apparatus 400 generates the third operational mode setting signal and transmits it to the network camera 300 (S210). Then, the network camera 300 transmits the image analyzing data and/or the image preserving data along with the image live data to the data receiving apparatus 400 (S211).

The exemplary embodiments of the present invention generate the image analyzing data based on the photographed images in the data transmission apparatus and transmit the image analyzing data when the network transmission bandwidth is smaller than the predetermined threshold value, thereby making it possible to continuously receive data that can be monitored in the data receiving apparatus. In other words, the exemplary embodiments of the present invention can continuously monitor the data in the data receiving apparatus regardless of the network transmission bandwidth.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A data transmission apparatus, comprising:
an encoder that encodes photographed images to generate image live data;
an image analyzing data generator that generates image analyzing data based on the photographed images; and
a controller that controls the image analyzing data generator to generate the image analyzing data.

2. The data transmission apparatus according to claim 1, wherein the data transmission apparatus further includes:
a network transmission band calculator that calculates a network transmission bandwidth to which the data transmission apparatus belongs; and
a network communication unit that transmits at least one of the image live data and the image analyzing data according to the calculated network transmission band to the outside.

3. The data transmission apparatus according to claim 2, wherein the data transmission apparatus further includes a storage unit that stores the image live data and the image analyzing data in an independent space.

4. The data transmission apparatus according to claim 3, wherein the controller controls the network communication unit to transmit the image analyzing data to the outside and controls the storage unit to store the image live data in another separate space as an image preserving data when the calculated network transmission bandwidth is smaller than the predetermined threshold value.

5. The data transmission apparatus according to claim 4, wherein the storage unit includes:
a first memory that stores the image live data;
a second memory that stores the image analyzing data; and
a third memory that stores the image preserving data.

6. The data transmission apparatus according to claim 4, wherein the controller controls the network communication unit to transmit the image live data to the outside when the calculated network transmission bandwidth is larger than the predetermined threshold value.

7. The data transmission apparatus according to claim 4, wherein the controller controls the network communication unit to transmit at least one of the image analyzing data and the image preserving data along with the image live data to the outside when the calculated network transmission bandwidth is larger than the predetermined threshold value.

8. The data transmission apparatus according to claim 7, wherein the data transmission apparatus further includes a data list managing unit that manages the registration and deletion of the image preserving data using a list.

9. The data transmission apparatus according to claim 8, wherein the controller controls the data list managing unit to register the corresponding image preserving data in the list when the image live data is stored as the image preserving data and controls the data list managing unit to delete the corresponding image preserving data from the list when the image preserving data is transmitted to the outside.

10. The data transmission apparatus according to claim 1, wherein the image analyzing data includes at least one of face recognizing information, expression recognition information, moving body recognition information, moving body tracing information, character recognition information, and identity detection information, scene change information that are extracted from the photographed images.

11. A data transmission method, comprising:
(A) encoding photographed images by an encoder to generate image live data and generating image analyzing data by an image analyzing data generator based on the photographed images;
(B) storing the image live data and the image analyzing data in an independent space by a storage unit; and
(C) transmitting at least one of the image live data and the image analyzing data to the outside by a network communication unit according to the corresponding network transmission bandwidth.

12. The data transmission method according to claim 11, wherein step (C) includes:
(C-1) calculating the network transmission bandwidth by the network transmission band calculator;
(C-2) confirming whether the calculated network transmission bandwidth is smaller than the predetermined threshold value by the controller; and
(C-3) when the calculated network transmission bandwidth is smaller than the predetermined threshold value, the controller includes controlling the network communication unit to transmit the image analyzing data to the outside.

13. The data transmission method according to claim 12, further comprising: after step (C-3), (C-4) controlling, by the controller, the storage unit to store the image live data into another separate space as the image preserving data.

14. The data transmission method according to claim 13, further comprising: after step (C-2), (C-20) controlling, by the controller, the network communication unit to transmit the image live data to the outside when the calculated network transmission bandwidth is larger than the predetermined threshold value.

15. The data transmission method according to claim 13, further comprising: after step (C-2), (C-200) controlling, by the controller, the network communication unit to transmit at least one of the image analyzing data and the image preserving data along with the image live data to the outside when the calculated network transmission bandwidth is larger than the predetermined threshold value.

16. A network data transmission system, comprising:
a data receiving apparatus that generates an image analyzing data setting signal and transmits it to the outside and generates an operational mode setting signal according to the corresponding network transmission bandwidth and transmits it to the outside; and
a data transmission apparatus that encodes photographed images to generate image live data, generates image analyzing data based on the photographed images according to the image analyzing data setting signal, and controls at least one of the image live data and the image analyzing data to the data receiving apparatus according to the operational mode setting signal.

17. The network data transmission system according to claim 16, wherein the data receiving apparatus generates a first operational mode setting signal and transmits it to the data transmission apparatus when the corresponding network transmission bandwidth is smaller than the predetermined threshold value.

18. The network data transmission system according to claim 17, wherein the data transmission apparatus transmits the image analyzing data to the data receiving apparatus and stores the image live data in another separate space as image preserving data.

19. The network data transmission system according to claim 17, wherein the data receiving apparatus generates a second operational mode setting signal and transmits it to the data transmission apparatus when the corresponding network transmission bandwidth is larger than the predetermined threshold value.

20. The network data transmission system according to claim 19, wherein the data transmission apparatus transmits the image live data to the data receiving apparatus.

21. The network data transmission system according to claim 20, wherein the data receiving apparatus generates a third operational mode setting signal and transmits it to the data transmission apparatus if the network transmission bandwidth has sufficient margin to transmit other data in addition to the image live data when the network transmission bandwidth is larger than the predetermined threshold value.

22. The network data transmission system according to claim 21, wherein the data transmission apparatus transmits at least one of the image analyzing data and the image preserving data along with the image live data to the data receiving apparatus.

23. The network data transmission system according to claim 22, wherein the data transmission apparatus registers the corresponding image preserving data in the list when the image live data is stored as the image preserving data and deletes the corresponding image preserving data from the list when the image preserving data is transmitted to the data receiving apparatus.

24. The data transmission apparatus according to claim 16, wherein the image analyzing data includes at least one of face recognizing information, expression recognition information, moving body recognition information, moving body tracing information, character recognition information, and identity detection information, scene change information that are extracted from the photographed images.

25. A network data transmission method, comprising:
(a) generating an image analyzing data setting signal by a data receiving apparatus and transmitting it to the data transmission apparatus;
(b) encoding photographed images by the data transmission apparatus to generate image live data and generating image analyzing data based the photographed image according to the image analyzing data setting signal; and
(c) generating an operational mode signal by the data receiving apparatus according to the corresponding network transmission bandwidth and transmitting it to the data transmission apparatus.

26. The network data transmission method according to claim 25, wherein the step (c) includes:
(c-1) calculating the corresponding network transmission bandwidth by the data receiving apparatus;
(c-2) confirming by the data receiving apparatus whether the network transmission bandwidth is smaller than a predetermined threshold value;
(c-3) if it is determined that the network transmission bandwidth is smaller than the predetermined threshold value, generating a first operational mode setting signal by the data receiving apparatus and transmitting it to the data transmission apparatus; and
(c-4) transmitting the image analyzing data to the data receiving apparatus by the data transmission apparatus.

27. The network data transmission method according to claim 26, further comprising: after step (c-4), (c-5) storing, by the data transmission apparatus, the image live data in another separate space as image preserving data.

28. The network data transmission method according to claim 27, further comprising: after step (c-2),
(c-20) confirming, by the data receiving apparatus, whether the network transmission bandwidth has sufficient margin to transmit other data in addition to the image live data;
(c-21) if it is determined that there is no margin in the network transmission bandwidth to transmit other data in addition to the image live data, generating, by the data receiving apparatus, a second operational mode setting signal and transmitting it to the data transmission apparatus; and
(c-22) transmitting, by the data transmission apparatus, the image live data to the data receiving apparatus.

29. The network data transmission method according to claim 28, further comprising: after step (c-20),
(c-200) if it is determined that there is sufficient margin in the network transmission bandwidth to transmit other data in addition to the image live data, generating, by the data receiving apparatus, a third operational mode setting signal and transmitting it to the data transmission apparatus; and
(c-201) transmitting, by the data transmission apparatus, at least one of the image analyzing data and the image preserving data along with the image live data to the data receiving apparatus.
